(19) United States
(12) Patent Application Publication
(10) Pub. No.: US 2010/0043916 A1
(43) Pub. Date: Feb. 25, 2010

(54) FILLING SHOE AND METHOD FOR POWDER FILLING AND COMPACTION

(75) Inventors: Mikael Dahlberg, Nyhamnslage (SE); Naghi Solimanjad, Lerberget (SE)

Correspondence Address: BUCHANAN, INGERSOLL & ROONEY PC, POST OFFICE BOX 1404, ALEXANDRIA, VA, 22313-1404, US

(73) Assignee: HÖGANÄS AB, Hoganas (SE)

(21) Appl. No.: 12/515,172

(22) PCT Filed: Nov. 16, 2007
(86) PCT No.: PCT/SE2007/001016

§ 371 Date: May 15, 2009

Related U.S. Application Data
(60) Provisional application No. 60/860,494, filed on Nov. 22, 2006.

(30) Foreign Application Priority Data
Nov. 17, 2006 (SE) 0602444-2

(51) Int. Cl. B65B 1/20; C04B 35/645

(52) U.S. Cl. 141/12; 264/603; 141/71

(57) ABSTRACT

Disclosed is a filling shoe device for passing and dispensing powder into a cavity of a powder compaction apparatus for subsequent compacting of the powder, the filling shoe device comprising a filling shoe, the filling shoe comprises an inlet portion for receiving powder into said filling shoe, an outlet portion forming a powder outlet flow channel having an outlet opening for dispensing powder out of said filling shoe into the cavity in said powder compaction apparatus, a meshwork arranged in the powder flow channel across the outlet opening, and wherein the meshwork is non-movably arranged in the outlet portion and wherein the outlet portion is non-movable relative to the filling shoe device.

### FIELD OF THE INVENTION

The present invention relates to a filling shoe device for use in a powder compaction apparatus. The filling shoe comprises an inlet portion, for receiving powder into said filling shoe, and an outlet portion, the outlet portion forming a powder outlet flow channel having an outlet opening for dispensing powder out of said filling shoe into a cavity in said powder compaction apparatus.

The present invention further relates to methods for filling and compaction of a powder in a cavity of a powder compaction apparatus.

### BACKGROUND OF THE INVENTION

In a conventional powder compaction apparatus a powder is fed from a powder source to a filling shoe and from the filling shoe into a compaction cavity in a compaction die. When compaction is to be accomplished the filling shoe is removed from the opening of the compaction cavity by moving the filling shoe, the punches are then forcefully pressed against the powder in the compaction cavity.

It has been found that in many cases the density and performance of the final product will vary in an unsatisfactory manner. The density and performance may vary between different bodies of the same kind of product and/or within a single body. Another effect of uneven filling is that the amount of charged powder in the cavity will vary giving an unsatisfactory variation of weight between produced components.

One suggested solution to this problem is a design of the powder compaction apparatus where the problem is addressed by increasing the density of the powder filled into the cavity compared to the apparent density of the powder.

For example, U.S. Pat. No. 5,672,313 discloses a method for manufacturing a powder moulding and a powder feeder in order to pack a material with high and uniform density. The method comprises an oscillation of the powder material while it is in the shoe box until the density of the powder in the cavity increases to at least 1.1 times the apparent density. To effectively oscillate the powder in the shoe box, a plurality of top- and bottom-open cells, formed of upright standing partitioning plates, are provided in the shoe box. Within each cell the powder will be vibrated into a separate charge of slightly pre-compacted powder and each such charge will be provided into different portions of the compaction cavity. This design will thereby result in a relatively high filling density. However, there is a risk that there will be differences between the powder charges from each cell or that the charges will not be mixed with each other in the interfaces between each cell charge when filled into the cavity.

U.S. Pat. No. 3,893,791 discloses a similar apparatus for charging pressing dies. In this apparatus the filling shoe is provided with gratings within the filing shoe. The gratings are connected to drive means, thereby enabling the powder charge to be vibrated. In this design the grating is formed of intersecting sheet metal strips. The resulting design will thereby be subject to basically the same advantages and disadvantages as the design in U.S. Pat. No. 5,672,313.

A varying density is often caused by the fact that the particles constituting the powder tend to bridge or clog together and that air is entrapped in the powder bed.

Several solutions to this problem have been proposed for achieving a uniform distribution of the powder in the compaction cavity and thereby giving a uniform density of the powder compact. One solution is disclosed in U.S. Pat. No. 3,972,449. This document describes a powder feeding apparatus including a grid coupled to a means for reciprocating the grid at different rates during the dispensing of the powder into the cavity. The grid is arranged in a lower interior portion of the filling shoe and is reciprocatable in a horizontal plane. The grid is preferably made of closely spaced rods but may also be formed of a wire network such as a mesh or screen. The U.S. Pat. No. 3,972,449 patent emphasize and claim that the grid not only should be vibrated back and forth but also that the number of cycles per minute should be variable. The grid should be capable of being moved back and forth several hundreds cycles per minute. This kind of solution involves a complex design with a number of moving parts. It has also been found that this design may cause segregation of composite powders, which in turn may lead to unsatisfactory density distribution and also to dusting of fine particles, such as graphite. There is also a risk that the vibrations will lead to an unfavourable packing of the powder in the filling shoe, which in turn may give non-uniform filling.

In another conventional powder filling method, as disclosed in U.S. Pat. No. 5,881,357, a pipe having holes for discharging gas is disposed in a powder box. Gas is discharged into the powder in the powder box as the powder enters the cavity so that particles of the powder are movable relative to each other. Due to the gas discharge, the powder can enter the cavity smoothly without whirling up in the cavity and settling unevenly, so that a filling time period is shortened and particle size distribution is uniform. This design is however complicated and requires the provision of pressurised air to the filling shoe.

In another similar powder filling method, as disclosed in U.S. Pat. No. 6,475,430, a material is packed into a container by an air tapping process in which the air-pressure is switched several times from a low air-pressure state to a high air-pressure state alternately. By keeping said low air-pressure state equal to, or higher, than the atmospheric pressure existing outside said space, the material is prevented from getting blown upwards by the inflow of the atmospheric air outside the container. Subsequently the material is packed into said container homogeneously. This design is however complicated and requires the provision of pressurised air at two different air pressures.

Thus, there still exists a need for an improved apparatus and method for filling a powder into a compaction cavity.

### SUMMARY

An object of the present invention is to provide a stable, robust and simple structure solving the problem related to the undesired variation of the powder density in the filled cavity.

This is in accordance with the present invention achieved by a filling shoe device for passing and dispensing powder into a cavity of a powder compaction apparatus for subsequent compacting of the powder, the filling shoe device comprising a filling shoe, the filling shoe comprises:
an inlet portion for receiving powder into said filling shoe,
an outlet portion forming a powder outlet flow channel having an outlet opening for dispensing powder out of said filling shoe into the cavity in said powder compaction apparatus,
a meshwork arranged in the powder flow channel across the outlet opening, and
wherein the meshwork is non-movably arranged in the outlet portion and
wherein the outlet portion is non-movable relative to the filling shoe device.

The invention provides the advantage of being a stable, robust and simple structure, which secures a homogenous density of the powder in the filled cavity. The invention is also possible to apply in different kinds of existing pressing device without costly adaptation. The meshwork prevents the powder from bridging and entrapped air is able to discharge. Thereby the filling of the cavity is made uniformly in the volume of the cavity and a homogenous density of the powder in the cavity is obtained. Furthermore, the weight variation or weight scatter between the pressed parts are reduced.

Another advantage is that the filling shoe device comprises no moving parts, therefore a means for operating the movement is not required. The meshwork is non-movably, i.e. fixedly, arranged in the outlet portion and the outlet portion is non-movable relative to the entire filling shoe device, whereby no mechanical forces are applied or transferred to the filling shoe device in order to convey the powder through the filling shoe. By having the meshwork non-movable arranged in the outlet portion and the outlet portion being non-movable relative to the filling shoe device, there are no moving parts or no means for operating movement, and the filling shoe device will therefore be a simple device, which requires a minimum of operation and service. Furthermore, the technical features of the device may easily be applied and transferred to existing devices, which has the advantage that existing devices can continue be used and do not need to be replaced by new and special devices.

The meshwork may be arranged in the outlet portion at a distance less than 10 mm, preferably within 0-7 mm, most preferably 0-5 mm, from said outlet opening. Thereby the powder is prevented from any significant re-forming of bridges on its way from the meshwork into the cavity. Another advantage is that this allows adaptation of the meshwork to various powder constitutions in order to achieve an optimal filling. It should be noted that when determining the distance from the outlet opening, the outlet opening forming the interface with the cavity is the relevant starting point. If the outlet portion forming the outlet opening is provided with locking means or the like those are to be disregarded when determining said distance. In one embodiment the wires forming the meshwork are in contact with the die surface when the filling shoe is moved to and from the cavity opening. In other words; the surface of the meshwork facing the cavity is touching the interface plane or opening plane of the cavity.

The meshwork is provided with openings with a size of 1-200, preferably 1-100 mm² in order to prevent the bridging in an optimal way. Another advantage is that the proper choice of the size of the openings makes it possible to adapt the meshwork to the actual powder constitution.

Under some circumstances it may be preferable to let the meshwork only cover part of the filling shoe cross section area. Another advantage according to this feature is the possible adaptation to the powder used.

The filling shoe may further comprise a meshwork that completely covers the outlet opening. This feature results in the advantage of an optimal flow through the meshwork. A further advantage is that a short filling period is then possible.

In one embodiment the extension of the inlet portion in the filling shoe device is arranged to be adjustable for adjusting the amount of powder in the filling shoe device. This is an advantage of the present invention, since it may not be desirable to have too much powder in the filling shoe device, since the air in the inlet portion and in the filling shoe device preferably should be able to pass through the meshwork, and too much powder in the filling shoe device may disrupt the air passing through the meshwork. So by arranging and/or adjusting how far the inlet portion extends down in the filling shoe device, the amount of powder in the filling shoe device can be adjusted to be in accordance with a desirable and advantageous amount.

In one embodiment the inlet portion is a flow channel, e.g. in the from of a pipe member, extending from a distal end towards a proximal end proximal to the meshwork and arranged at a distance from the meshwork, the distance between the proximal end of the flow channel and the meshwork is adjustably arranged; the proximal end of the flow channel is arranged at an acute angle to the meshwork, and the outlet of the inlet portion is defined by a rim substantially parallel to the meshwork.

An advantage of this embodiment is that since the outlet rim is substantially parallel to the meshwork, the dispensing of powder through the powder flow channel may be a uniform distribution of powder across the meshwork. Furthermore, the dispensing of powder may occur in a controlled manner and raising of dust can be reduced when the powder passes the meshwork because of the parallel arrangement.

The present invention relates to different aspects including the filling shoe device described above and in the following, and corresponding methods for powder filling and compaction, and/or further devices or product means, each yielding one or more of the benefits and advantages described in connection with the first mentioned aspect, and each having one or more embodiments corresponding to the embodiments described in connection with the first mentioned aspect and/or disclosed in the appended claims.

The present invention further relates to a method for filling of a powder in a cavity of a powder compaction apparatus. The method comprises receiving a powder from a powder source by a filling shoe, passing the powder through a meshwork non-movably, i.e. fixedly, arranged in an outlet portion of the filling shoe, dispensing the powder from the outlet portion into said cavity, wherein passing and dispensing the powder is performed without movement operation.

An advantage is that the method represents a simple, reliable and robust method for filling powder in a cavity.

The method may comprise a step of using a filling shoe device, which is stationary arranged during the dispensing of the powder into the cavity. The advantage of this feature is a simplified method comprising fewer steps and an apparatus with fewer mechanisms.

As the passing and dispensing of powder is performed without any movement operation in the filling shoe device, the filing shoe device and the powder compaction apparatus may be simple devices or apparatuses, which require a minimum of operation and service. So the passing and dispensing or conveying of powder through the filling shoe device to the cavity happen without applying force to or performing movement of the filling shoe device, and in other words no mechanical conveyance means is used in relation to the filling shoe device for passing or dispensing powder. Furthermore, the filling shoe device may easily be applied in existing devices, such as powder compaction apparatuses, which has the advantage that existing devices can continue be used and do not need to be replaced by new and special devices.

In some embodiments the method further comprises compacting the powder in the cavity, thereby forming a compacted body.

This will result in a compacted body with a uniform density and less weight variation between compacted parts. A further advantage is that the method represents a simple, reliable and robust method for compacting the powder.

The method may additionally comprise the step of sintering of the compacted body.

It is preferred to use a filling shoe device in accordance with any one of the preferred embodiments in accordance with the discussion above in said method for filling and compaction of a powder in a cavity of a powder compaction apparatus.

In some embodiments methods of using a filling shoe device is disclosed.

### BRIEF DESCRIPTION OF THE DRAWINGS

The above and/or additional objects, features and advantages of the present invention, will be further elucidated by the following illustrative and non-limiting detailed description of embodiments of the present invention, with reference to the appended drawings, wherein:

The invention will by way of example be described in more detail with reference to the appended schematic drawings, which shows a presently preferred embodiment of the invention.

FIG. 1 shows a side view of the filling shoe above a cavity of a powder compaction apparatus.

FIG. 2 shows a side view of the filling shoe.

FIG. 3a shows a first embodiment of the meshwork of the filling shoe according to the invention.

FIG. 3b shows a second embodiment of the meshwork of the filling shoe according to the invention.

### DETAILED DESCRIPTION

In the following description, reference is made to the accompanying figures, which show by way of illustration how the invention may be practiced.

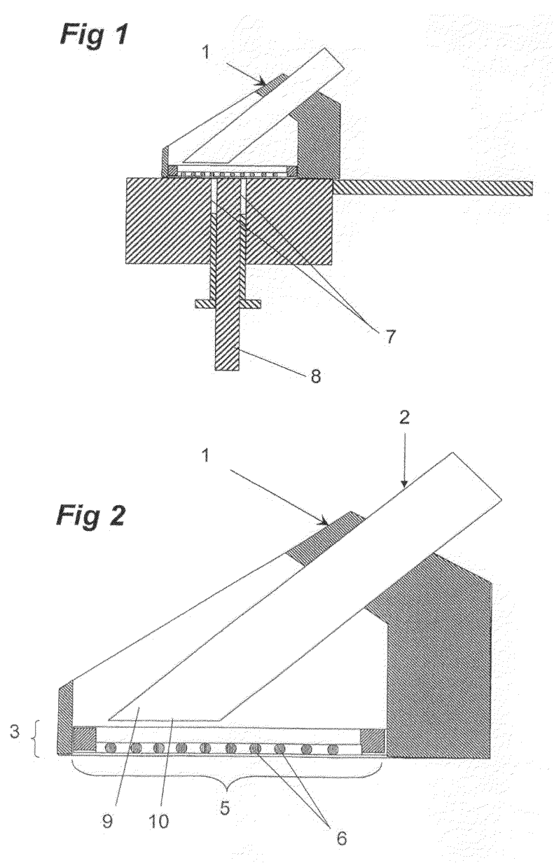

FIGS. 1-2 show a preferred embodiment of a filling shoe for use in a powder compaction apparatus. The filling shoe 1 basically comprises an inlet portion 2, an outlet portion 3 and a meshwork 6. The outlet portion 3 forms an powder outlet flow channel having an outlet opening 5. The powder compaction apparatus further comprises a cavity 7 in a die. In FIG. 1 the cavity 7 is annularly shaped using a core 8 within the cavity of the die.

According to FIG. 1, the filling shoe 1 is a part of a powder compaction apparatus. The filling shoe 1 is disposed above the cavity 7 of the powder compaction apparatus during dispensing. The inlet portion 2 of the filling shoe 1 is arranged to be connectable to a powder source. The outlet portion 3 of the filling shoe 1 is arranged to be releasably connected to the cavity 7.

FIG. 2 shows a side view of the filling shoe 1 and discloses the outlet portion 3 of the filling shoe 1, which forms the powder outlet flow channel having an outlet opening 5, and the meshwork 6. The meshwork 6 is fixedly arranged in the outlet portion 3 of the filling shoe 1. The meshwork 6 is arranged within the powder flow channel across the outlet opening 5. The meshwork 6 of the filling shoe 1 is arranged at a distance less than 10 mm, preferably within 0-7 mm, most preferably 0-5 mm from the outlet opening. In this embodiment the meshwork completely covers the outlet opening 5. The outlet opening 5 may in a preferred embodiment form a plane of interface with the inlet opening of the cavity 7. The meshwork 6 extends along said plane at said distance from the outlet opening.

The extension of the inlet portion 2 in the filling shoe 1 may be arranged to be adjustable for adjusting the amount of powder in the filling shoe 1.

FIGS. 1-2 furthermore show that the inlet portion 2 may be a pipe member extending from a distal end towards a proximal end 9 proximal to the meshwork 6 and arranged at a distance from the meshwork 6. The distance between the proximal end of the pipe and the meshwork 6 may be adjustable arranged at an acute angle to the meshwork 6, and the opening of the inlet portion 2 may be defined by a rim 10 substantially parallel to the meshwork 6.

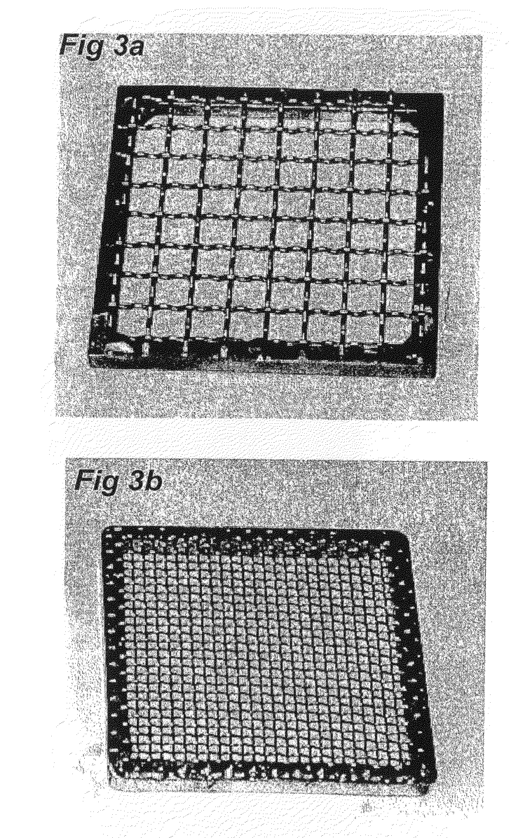

FIG. 3a and FIG. 3b show the meshwork 6 forming a grid or net. The grid is formed of a first series of a plurality of parallel, equidistant metal wires extending in a first direction and a second series of a plurality of parallel, equidistant metal wires extending in a second direction being orthogonal to said first direction. The thus formed openings are shaped as squares. In FIG. 3a the openings are 8 mm by 8 mm and in FIG. 3b the openings are 4 mm by 4 mm. In another embodiment, the openings of the meshwork 6 may be in form of circular openings. Other shapes such as elliptic, rectangular, rhombic are also contemplated. Each opening has preferably a size of 1-100 mm². In accordance with one embodiment all the openings in a given meshwork 6 are of the same size and shape.

In this embodiment, the meshwork 6 is formed of metal wires, but in another embodiment the meshwork may be formed of a perforated plate or the like essentially extending along the plane of the outlet opening.

For dispensing a powder in the cavity of the powder compaction apparatus, the powder is received in the inlet portion 2 of the filling shoe 1 from a powder source. The powder is transported through the inside of the filling shoe 1. In the outlet portion 3 of the filling shoe 1 the powder passes through the powder outlet flow channel and the outlet opening 5, thereby passing through the meshwork 6 fixedly arranged across the outlet opening 5 in the powder flow channel. The powder is thereby dispensed into the cavity 7.

The powder is thereafter compacted within the cavity using a punch which presses and compacts the powder within the cavity, thereby forming a compacted body. The body may then be sintered for further processing.

When the cavity 7 is to be filled, a movement between the filling shoe 1 and the cavity 7 is performed by transferring the filling shoe 1 until the opening of the cavity 7 and the outlet opening of the filling shoe 1 is in register. When the powder in the cavity 7 is to be compacted a relative movement between the filling shoe 1 and the cavity 7 is performed until the opening of the cavity 7 is exposed to a punch. The powder is compacted by lowering a punch into the cavity 7. Alternatively the exposed opening of the cavity 7 is covered by a die portion and the punch is introduced against the powder from the opposite direction. In such a design a simultaneous lowering of the punch (i.e. an enlargement of the cavity) during filling may be used to create a slight under-pressure, thereby facilitating the filling of the cavity. Thus, it is contemplated to adapt the present invention for use in different powder compaction apparatuses utilising different filling configurations, such as gravitational filling and so-called suction filling.

During the dispensing of the powder into the cavity 7 the filling shoe 1 may be stationary arranged. The size and shape of the openings of the meshwork 6, as well as the total area of the openings, are parameters which may be adapted to match the specific powder provided to the powder compaction apparatus. In addition, the distance from the outlet portion 3 to the position of meshwork 6 and the extension of the meshwork 6 are also parameters that may be adapted to match different powder constitutions in order to obtain a homogenous density in the cavity 7. It is thus possible to find a particular design of the meshwork 6 to match a certain powder constitution.

Test results have shown that with a fixedly arranged meshwork 6 in the filling shoe, it is possible to reduce the weight scatter of the manufactured bodies. Even with a higher filling speed (strokes/minute), a reduced standard deviation is obtained. Therefore it is possible to find an adequate relation between the design of the meshwork 6 and the filling and compaction rate resulting in a optimal filling of the cavity 7.

In the following two exemplifying sets of experiments will be discussed in more detail.

### Example 1

An iron-based powder composition was prepared based on a pure iron powder ASC 100.29, available from Höganäs A B, Sweden, further comprising 2.0% Cu powder 100 mesh, 0.8% graphite UF4, 0.8% amide wax, ethylenebis-stearamide.

The powder composition was transported to a container located above the compaction equipment. From the container a tube extend down to the filling shoe. The width of the filling shoe is 8.5 cm, the length is 8.5 cm, the height at the front end is 2.5 cm and 5 cm at the back end. The bottom of the filling shoe is open. When the filling shoe was moved to a position above the cavity it will be filled with powder. After the cavity was filled the filling shoe is withdrawn and the compaction may commence.

200 rings with a height of 13 mm, inner diameter 19 mm, outer diameter 25 mm was pressed with a pressure of 600 MPa. Nominal weight was about 19 gram. The pressing speed was 14 strokes/minute. After pressing the weight of each ring was determined and the standard deviation in weight was calculated.

Thereafter a meshwork in the form of a net with the mesh size of 4 mm was mounted at the bottom of the filling shoe. 200 rings was pressed at a pressing speed of 14 strokes/minute and 200 rings was pressed at a pressing speed of 16 strokes/minute. The weight of each of the rings was determined and the standard deviation in weight was determined for each pressing speed. Thereafter a net with the mesh size of 8 mm was mounted instead and the experiments was repeated.

TABLE 1
Experiments according to example 1

| | Mesh | | | Standard |
|---|---|---|---|---|
| | size | Number of | Pressing speed | deviation |
| | (mm) | rings | (strokes/minute) | (gram) |
| Filling shoe | N/A | 200 | 14 | 0.046 |
| without any | | | | |
| meshwork | | | | |
| Filling shoe | 4 | 200 | 14 | 0.012 |
| with meshwork | | | | |
| Filling shoe | 4 | 200 | 16 | 0.021 |
| with meshwork | | | | |
| Filling shoe | 8 | 200 | 14 | 0.029 |
| with meshwork | | | | |
| Filling shoe | 8 | 200 | 16 | 0.022 |
| with meshwork | | | | |

From table 1 it may be noted that the weight scatter is significantly smaller, at the same pressing speed (14 strokes/minute), when a meshwork was placed in the filling shoe compared to when no meshwork was used. It may also be noted that if the meshwork is used the weight scatter still remains significantly smaller compared to the reference test (14 strokes/minute) without meshwork even when the pressing speed is increased to 16 strokes/minute.

### Example 2

The same experimental set-up was used as in example 1. A bonded powder composition based on pure iron powder ASC 100.29, available from Höganäs A B, further comprising 2.0% Cu powder 100 mesh, 0.8% graphite UF4, 0.8% amide wax, ethylenebisstearamide, and 0.05% of a tall-oil-ester-based binding agent.

TABLE 2
Experiments according to example 2

| | | | | Standard |
|---|---|---|---|---|
| | Mesh size | Number of | Pressing speed | deviation |
| | (mm) | rings | (strokes/minute) | (gram) |
| Filling shoe | N/A | 200 | 11.5 | 0.139 |
| without any | | | | |
| meshwork | | | | |
| Filling shoe | 4 | 200 | 11.5 | 0.072 |
| with meshwork | | | | |
| Filling shoe | 4 | 200 | 14 | 0.024 |
| with meshwork | | | | |
| Filling shoe | 4 | 200 | 16 | 0.049 |
| with meshwork | | | | |
| Filling shoe | 8 | 200 | 11.5 | 0.019 |
| with meshwork | | | | |
| Filling shoe | 8 | 200 | 14 | 0.038 |
| with meshwork | | | | |

From table 2 it may be noted that the weight scatter is significantly smaller, at the same pressing speed (11.5 strokes/minute), when a meshwork was placed in the filling shoe compared to when no meshwork was used. It may also be noted that if the meshwork is used the weight scatter still remains significantly smaller compared to the reference test (11.5 strokes/minute) without meshwork even when the pressing speed is increased to 14 or 16 strokes/minute.

It is contemplated that there are numerous modifications of the embodiments described herein, which are still within the scope of the invention as defined by the appended claims.

The openings of a given meshwork may e.g. have different shapes and/or different sizes. The variation in shape and/or size may be alternating or dependent upon the location of the opening in relation to extension of the outlet opening.

Although some embodiments have been described and shown in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A filling shoe device for passing and dispensing powder into a cavity of a powder compaction apparatus for subsequent compacting of the powder, the filling shoe device comprising a filling shoe, the filling shoe comprises:
an inlet portion for receiving powder into said filling shoe,
an outlet portion forming a powder outlet flow channel having an outlet opening for dispensing powder out of said filling shoe into the cavity in said powder compaction apparatus,
a meshwork arranged in the powder flow channel across the outlet opening, and
wherein the meshwork is non-movably arranged in the outlet portion and wherein the outlet portion is non-movable relative to the filling shoe device.

2. The filling shoe device according to claim 1 comprising no moving parts for passing the powder through the filling shoe.

3. The filling shoe device according to claim 1, wherein said meshwork is arranged in the outlet portion at a distance less then 10 mm; from said outlet opening.

4. The filling shoe device according to claim 1, wherein the meshwork has openings with a size of 1-200 mm².

5. The filling shoe device according to claim 1, wherein the meshwork covers a part of the outlet opening.

6. The filling shoe device according to claim 1, wherein the extension of the inlet portion in the filling shoe is arranged to be adjustable for adjusting the amount of powder in the filling shoe.

7. The filling shoe device according to claim 1, wherein the inlet portion is a flow channel extending from a distal end towards a proximal end to the meshwork and arranged at a distance from the meshwork, the distance between the proximal end of the flow channel and the meshwork is adjustably arranged; the proximal end of the flow channel is arranged at an acute angle to the meshwork, and the outlet of the inlet portion is defined by a rim substantially parallel to the meshwork.

8. A method for filling a powder in a cavity of a powder compaction apparatus, comprising:
receiving a powder from a powder source by a filling shoe device,
passing the powder through a meshwork non-movably arranged in an outlet portion of the filling shoe device, and
dispensing the powder from the outlet portion into said cavity,
wherein passing and dispensing the powder is performed without movement operation.

9. The method according the claim 8, wherein said filling shoe device is stationary arranged during the dispensing of the powder into the cavity.

10. The method according to claim 8, further comprising compacting the powder in the cavity, thereby forming a compacted body.

11. The method according to claim 10, further comprising sintering of the compacted body.

12. The method according to claim 8, comprising using a filling shoe device comprising:
an inlet portion for receiving powder into said filling shoe,
an outlet portion forming a powder outlet flow channel having an outlet opening for dispensing powder out of said filling shoe into the cavity in said powder compaction apparatus,
a meshwork arranged in the powder flow channel across the outlet opening, and
wherein the meshwork is non-movably arranged in the outlet portion and wherein the outlet portion is non-movable relative to the filling shoe device.

13. The filling shoe device according to claim 2, wherein said meshwork is arranged in the outlet portion at a distance less then 10 mm from said outlet opening.

14. The filling shoe device according to claim 2, wherein the meshwork has openings with a size of 1-200 mm².

15. The filling shoe device according to claim 3, wherein the meshwork has openings with a size of 1-200 mm².

16. The filling shoe device according to claim 2, wherein the meshwork covers a part of the outlet opening.

17. The filling shoe device according to claim 3, wherein the meshwork covers a part of the outlet opening.

18. The filling shoe device according to claim 2, wherein the extension of the inlet portion in the filling shoe is arranged to be adjustable for adjusting the amount of powder in the filling shoe.

19. The filling shoe device according to claim 3, wherein the extension of the inlet portion in the filling shoe is arranged to be adjustable for adjusting the amount of powder in the filling shoe.

20. The method according to claim 9, further comprising compacting the powder in the cavity, thereby forming a compacted body.
